(19) United States
(12) Patent Application Publication
(10) Pub. No.: US 2002/0186528 A1
(43) Pub. Date: Dec. 12, 2002

(54) Notebook computer with folding speaker device

(76) Inventor: Yu-Fu Huang, Taoyuan (TW)

Correspondence Address: RABIN & BERDO, P.C., SUITE 500, 1101 14th STREET, N.W., WASHINGTON, DC, 20005, US

(21) Appl. No.: 10/084,146

(22) Filed: Feb. 28, 2002

(30) Foreign Application Priority Data
Jun. 6, 2001 (TW) 90209417

(51) Int. Cl. G06F 1/16

(52) U.S. Cl. 361/683; 361/680

(57) ABSTRACT

A notebook computer with folding speaker device comprises a base unit, a covering board and a speaker device. The covering board is connected to the base unit in a folding way with the speaker device being connected to one side of the covering board in a folding way. The speaker can even be connected to one side of the covering board in a detachable way. Of which, the speaker device can be installed at the two corresponding sides of the covering board. The speaker device according to the design of the invention is movable and can be folded to the two sides of the covering board. The speakers can also be folded to the top of the covering board or the two sides of the base unit which is indeed very convenient.

This application incorporates by reference Taiwanese application Serial No. 90209417, Filed Jun. 6, 2001.

### BACKGROUND OF THE INVENTION

1. Field of the Invention

The invention relates in general to a notebook computer, and more particularly to a notebook computer with folding speaker device.

2. Description of the Related Art

Along with the advance in technology, the use of computer has become more and more popular. Nowadays, the computer has become an indispensable appliance for modern people in their everyday lives, especially the notebook computer, which has won great popularity with modem people who strive for efficiency because of the features of compactness and portability.

Please refer to FIG. 1, a three-dimensional schematic diagram of a conventional notebook computer is illustrated. The notebook computer 100 according to FIG. 1 includes a base unit 102 and a covering board 104, wherein the covering board 104 is connected to the base unit using a pivotal spindle 106 such that the covering board 104 can close to and open from the base unit 102. Furthermore, the base unit 102 comprises a keyboard session 108 with which the user inputs operation signals, and a speaker device 110 whereby audio effect is provided. Of which, the covering board 104 comprises a display panel 112, a Liquid Crystal Display (LCD) for instance, used to display signals.

It is noteworthy that the power and volume of the speaker 110, which is built-in inside the notebook computer 100, is restricted due to the limited volume and space of the base unit 102 resulting in a poor quality of audio effect. Moreover, a conventional speaker 110 cannot produce the same stereo effect like the two speakers situated at both sides of an ordinary TV set would do. Therefore, the design and location of the speaker 110 is indeed an important issue.

### SUMMARY OF THE INVENTION

It is therefore an object of the invention to provide a notebook computer with folding speaker device. The design of the speaker device according to the invention is movable and can be folded to the two sides of the covering board. When the notebook computer is to be carried away, the speaker device can be folded to the top of the covering board or the two sides of the base unit. It is indeed very convenient to the user.

According to the object of the invention, a notebook computer with folding speaker device including a base unit, a covering board and a speaker device is provided. The covering board is connected to the base unit in a folding way while the speaker device is connected to one side of the covering board in a folding way.

According to another object of the invention, a notebook computer with folding speaker device including a base unit, a covering board and a speaker device is provided. The covering board is connected to the base unit in a folding way while the speaker device is connected to one side of the covering board in a detachable way.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 shows a three dimensional schematic diagram of a conventional notebook computer;

FIG. 2A shows a three dimensional schematic diagram of a notebook computer with folding speaker device according to Embodiment One of the invention;

FIG. 2B shows a three dimensional schematic diagram of a notebook computer with the speaker device being folded to the top of the covering board;

FIG. 3A shows a three dimensional schematic diagram of a notebook computer with folding speaker device according to Embodiment Two of the invention; and

FIG. 3B shows a three dimensional schematic diagram of a notebook computer with the speaker device being folded to both sides of the base unit.

### DESCRIPTION OF THE PREFERRED EMBODIMENT

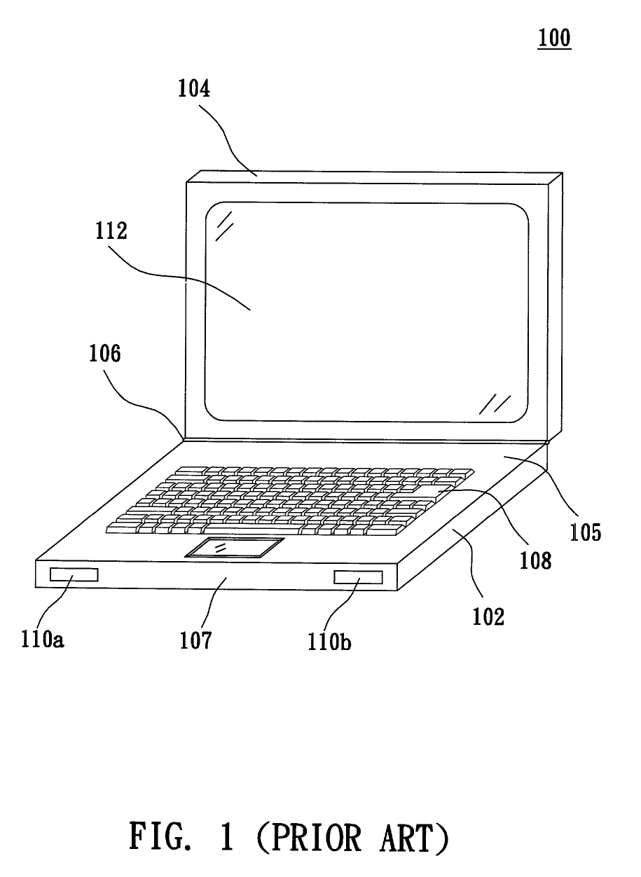

Unlike the built-in speaker device of a conventional notebook computer as shown in FIG. 1, the folding speaker device according to the particular design of the invention is installed at both sides of the covering board via a linking device and is movable. The design produces a larger power output, better audio quality and stereo effect than the conventional speaker device in FIG. 1 would do. The practical application of the invention is disclosed in the following preferred embodiments of the invention, Embodiment One and Embodiment Two, respectively:

Embodiment One:

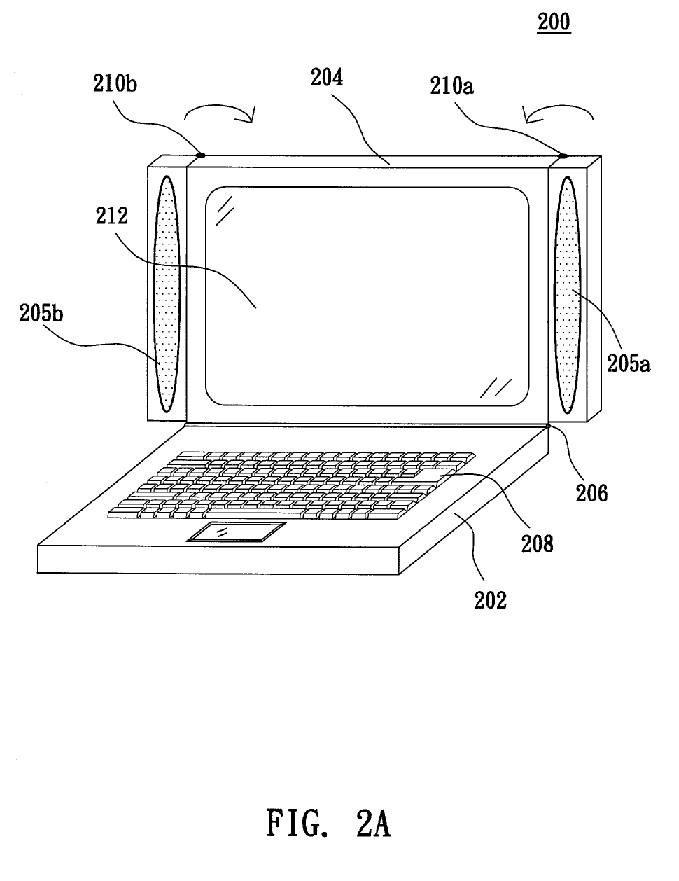

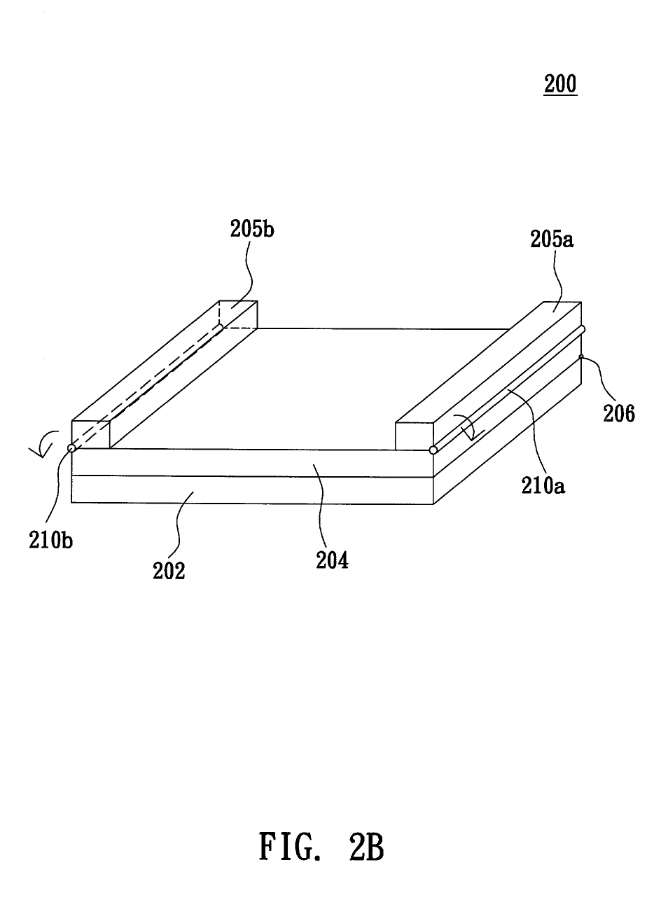

Referring to FIG. 2A, a three dimensional schematic diagram of a notebook computer with folding speaker device according to Embodiment One of the invention is illustrated. The notebook computer 200 in FIG. 2A includes a base unit 202, a covering board 204 and two speaker devices 205a and 205b. The covering board 204 is connected to the base unit 202 via a pivotal spindle 206 allowing the covering board 204 to close to and open from the base unit 202 while the base unit 204 comprises a keyboard session 208 with which the user inputs operation signals. Of which, the covering board compromises a display panel 212, a Liquid Crystal Display (LCD) for instance, used to display signals; while the speaker devices 205a and 205b are connected to the two sides of the covering board 204 via a linking device, pivotal spindles 210a and 210b for instance, such that the speaker devices 205a and 205b are movable at the two sides of the covering board 204.

Besides, if the notebook computer 200 is to be carried away, the user simply needs to close the covering board 204 to the base unit 202 and fold the speaker devices 205a and 205b in the direction of the arrow towards the reverse side of the display panel 212 around the spindles 210a and 210b. The speaker devices 205a and 205b will be folded to the top of the covering board 204 as shown in FIG. 2B providing convenience of portability to the user. If the notebook computer 200 is to be used, the user simply needs to reverse the foregoing procedures by unfolding the speaker devices 205a and 205b to the two sides of the covering board 204 in the direction of the arrow shown in FIG. 2B. A stereo effect of audio enjoyment will be provided accordingly.

Preferred Embodiment Two:

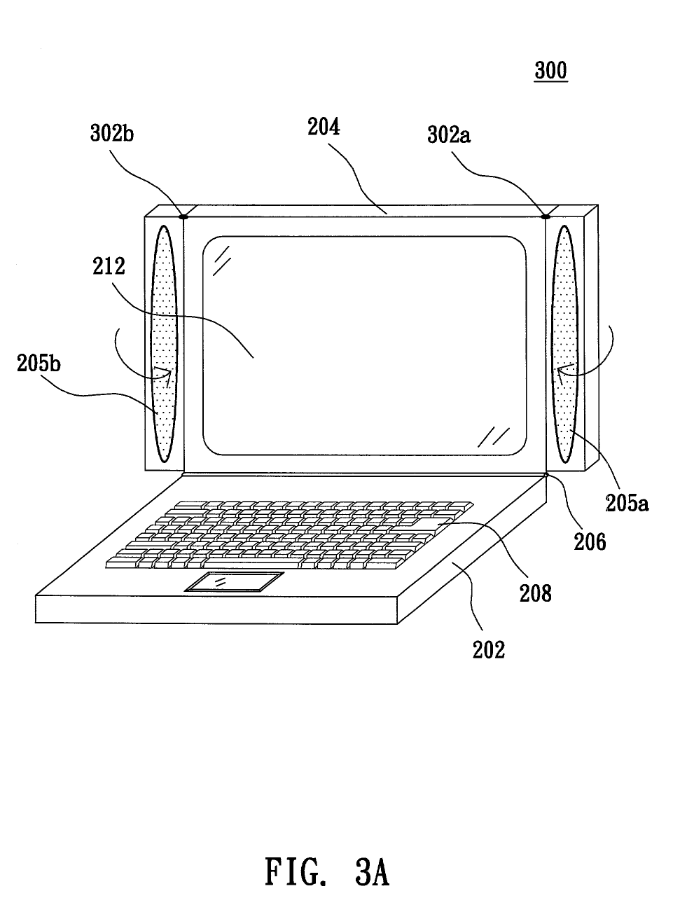

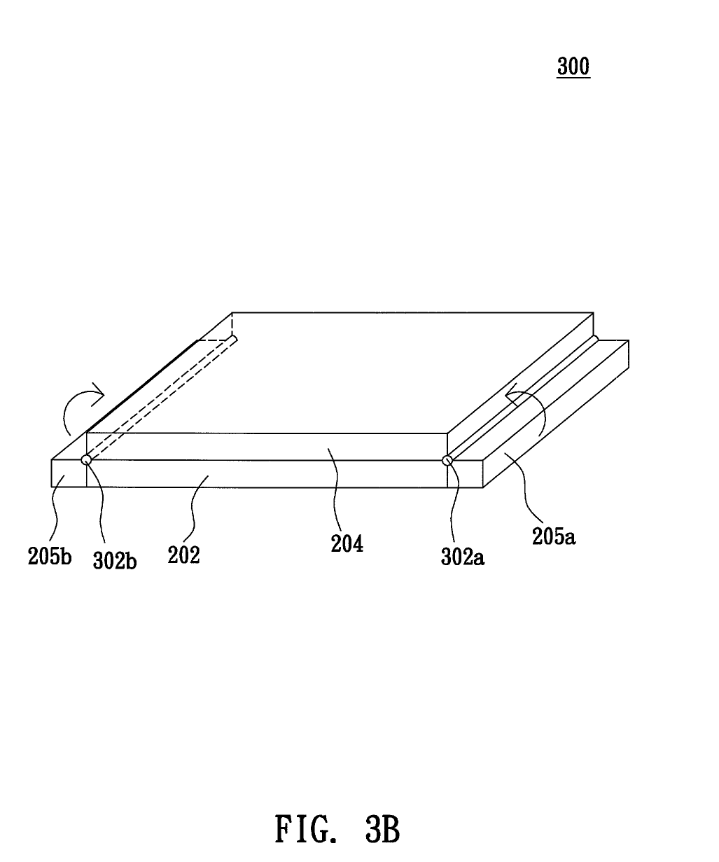

Referring to FIG. 3A, a three dimensional schematic diagram of a notebook computer with folding speaker device according to Embodiment Two of the invention is illustrated. The notebook computer 200 in FIG. 2A includes a base unit 202, a covering board 204 and two speaker devices 205a and 205b. The covering board 204 is connected to the base unit 202 via a pivotal spindle 206 allowing the covering board 204 to close to and open from the base unit 202 while the base unit 204 comprises a keyboard session 208 with which the user inputs operation signals. Of which, the covering board compromises a display panel 212, a Liquid Crystal Display (LCD) for instance, used to display signals; while the speaker devices 205a and 205b are connected to the two sides of the covering board 204 via a linking device, two pivotal spindles 302a and 302b for instance, such that the speaker devices 205a and 205b are movable at the two sides of the covering board 204.

Besides, if the notebook computer 200 is to be carried away, the user simply needs to close the covering board 204 to the base unit 202 and fold the speaker devices 205a and 205b in the direction of the arrow towards the two sides of the base unit 202 around the pivotal spindles 302a and 302b. The speaker devices 205a and 205b will be folded to the two sides of the base unit 202 as shown in FIG. 3B providing convenience of portability to the user. If the notebook computer 200 is to be used, the user simply needs to reverse the foregoing procedures by unfolding the speaker devices 205a and 205b to the two sides of the covering board 204 in the direction of the arrow shown in FIG. 3B. A stereo effect of audio enjoyment will be provided accordingly.

A notebook computer with folding speaker device according to the invention is disclosed in the above embodiments. The speaker device according to the design in the invention is movable and can be folded to the two sides of the covering board. The speaker device can also be folded to the top of the covering board or the two sides of the base unit which is indeed very convenient.

While the invention has been described by way of example and in terms of the preferred embodiment, it is to be understood that the invention is not limited to the disclosed embodiment. For instance, although two folding speakers are used as an example of explanation in the abovementioned preferred embodiments, the choice of speaker depends on the consumer's needs when it comes to practical application. Furthermore, a detachable design of speaker can also be adopted to achieve the desired effects of the invention. Therefore, the scope of protection of the invention is defined in the appended claims; and it is to be understood that invention is intended to cover various modifications and similar arrangements and procedures, and the scope of the appended claims therefore should be accorded the broadest interpretation so as to encompass all such modifications and similar arrangements and procedures.

What is claimed is:

1. A notebook computer with folding speaker device, comprising:
a base unit;
a covering board; and
a first speaker device connected to one side of the covering board in a folding way.

2. A notebook computer according to claim 1, further comprising:
a second speaker device connected to another side of the covering board in a folding way corresponding to the first speaker device.

3. A notebook computer with folding speaker device, comprising:
a base unit;
a covering board; and
a first speaker device connected to one side of the covering board in a detachable way.

4. A notebook computer according to claim 3, further comprising:
a second speaker device connected to another side of the covering board in a detachable way corresponding to the first speaker device.
